(19) United States
(12) Patent Application Publication
(10) Pub. No.: US 2022/0099794 A1
(43) Pub. Date: Mar. 31, 2022

(54) METHOD AND APPARATUS FOR A CHIRP GENERATOR IN A RADAR SYSTEM

(71) Applicant: Metawave Corporation, Carlsbad, CA (US)

(72) Inventor: Andreas Falkenberg, Escondido, CA (US)

(21) Appl. No.: 17/489,588

(22) Filed: Sep. 29, 2021

Related U.S. Application Data
(60) Provisional application No. 63/084,896, filed on Sep. 29, 2020.

(51) Int. Cl. G01S 7/35; G01S 13/58; G01S 13/931; G01S 13/06

(52) U.S. Cl. CPC G01S 7/35; G01S 13/06; G01S 13/931; G01S 13/584

(57) ABSTRACT

A radar signal generation system is provided. The system includes a controller configured to set parameters for signal generation. The system includes a chip generator for generating a frequency modulated continuous wave (FMCW) signal. The system is configured to recursively perform a series of operations to update the chirp signal value. The chip generator includes a plurality of multiplication modules, a plurality of operand units, where each operand unit stores an operand and each operand unit is coupled to a multiplication module of the plurality of multiplication modules, and an output storage unit. The system also includes a parameter interface module coupled to the controller and configured to set an operand value for each of the plurality of operand units. The controller can be configured for calculating operand values for a series of operations.

### CROSS-REFERENCE TO RELATED APPLICATIONS

This application claims priority from U.S. Provisional Application No. 63/084,896, filed on Sep. 29, 2020, which is incorporated by reference in its entirety.

### BACKGROUND

Radar systems for automotive system capture large amounts of data and process to provide real time instructions. As these systems move from automated driver assistance systems (ADAS) to fully autonomous operation the amounts of data and processing burden will continue to increase.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 illustrates a radar system, in accordance with various embodiments of the subject technology;

FIG. 2 illustrates frequency modulated continuous wave radar signals, in accordance with various embodiments of the subject technology;

FIG. 3 illustrates a chirp generator block diagram, in accordance with various embodiments of the subject technology;

FIGS. 4 and 5 illustrate portions of a radar signal for chirp generation, in accordance with various embodiments of the subject technology;

FIG. 6 illustrates a process for a radar system, in accordance with various embodiments of the subject technology;

FIG. 7 illustrates a process for a radar system, in accordance with various embodiments of the subject technology;

FIG. 8 illustrates a radar system, in accordance with various embodiments of the subject technology;

FIG. 9 illustrates a process for the generating signals for a radar system, in accordance with various embodiments of the subject technology; and

FIG. 10 illustrates a flowchart for an example method of generating a radar signal, in accordance with one or more implementations of the subject technology.

### DETAILED DESCRIPTION

The present invention provides methods and apparatuses for fast object detection and understanding that allows for real time decision-making. The radar system receives data at a receive antenna made of arrays of radiating elements. These signals interact with targets, or objects in the area covered by the radar unit, and return to the radar unit with a time delay compared to the transmitted signal. The target parameters, such as range, may be measured by a change in frequency at the receiver, wherein this change in frequency is referred to as a beat frequency. Increasing the number of radiating elements to receive the radar echo signals improves angular resolution and identification of targets and correspondingly the amount of data to process. By implementing sparse array techniques, the present disclosure creates virtual aperture antennas to enhance direction of arrival and other receive signal processing.

The radar system can be deployed on a vehicle with radar units. The radar units are provided on various locations of a vehicle to interpret and understand the vehicle's environment and avoid target objects that may interfere with the safe movement of the vehicle. For example, a first radar unit can be located in the front of the vehicle and a second radar unit can be located at the rear of the vehicle.

Frequency modulated continuous wave (FMCW) radar radiates continuous transmission power changing its operating frequency during the measurement, transmission and reception of the signals. The signals are reflected and the echo is received at the radar unit. The transmission signal is modulated in frequency or in phase over time. The received echo signal has a slightly different frequency compared to the signal transmitted at that moment, wherein the frequency difference is directly proportional to the echo delay, which can vary based on the distance from the transmitter to the detected target. The radar compares the frequencies of the transmit signal and the receive signals. The change in frequency provides a time delay, Δt, for the signal round trip or twice the range to the target, and the change in frequency is also used determine the velocity from the Doppler shift.

There are a variety of applications for radar, such as automotive, healthcare, industrial and so forth. FMCW modulation is a good choice for radar, enabling accurate measurement of very small ranges, or distance to the target; the minimal measured range is related to the transmitted wavelength. FMCW radar is used for driver assist systems, sensors and self-driving vehicle capabilities as these applications have strict requirements in different environments and all weather conditions. There is a desire to improve performance of FMCW radar. In FMCW radar, the transmit signal is generated by frequency modulating a continuous wave signal. In one sweep of the radar operation, the frequency of the transmit signal varies linearly with time. This kind of signal is also known as the chirp signal. The transmit signal sweeps a frequency, f, in one chirp duration. Due to the propagation delay, the received signal reflected from a target has a frequency difference, called the beat frequency, compared to the transmit signal. The range of the target is proportional to the beat frequency. Thus, by measuring the beat frequency, the target range is obtained.

FMCW radar accomplishes distance measurements by comparing the frequency of the received echo signal to a reference signal, which in this system is the transmit signal. The range, R, to the reflecting object is given as:

$$R = \frac{{c}_{0} \vert Δ t \vert}{2} = \frac{{c}_{0} \vert Δ f \vert}{2 ( \frac{d ( f )}{d ( t )}}$$

where c₀ is speed of light, Δt is delay time, Δf is measured frequency difference

$$\frac{d f}{d t}$$

is the frequency shift per unit time.

For frequency change that is linear, the radar range is determined by frequency comparison. The frequency difference, Δf is proportional to the range, R. When the reflecting object has a radial speed with respect to the receiving antenna, then the echo signal incurs a Doppler frequency f_{D} due to speed. The radar measures not only the difference frequency, Δf, to the current frequency, but a Doppler frequency f_{D}. The period of the FMCW signal is referred to as the chirp.

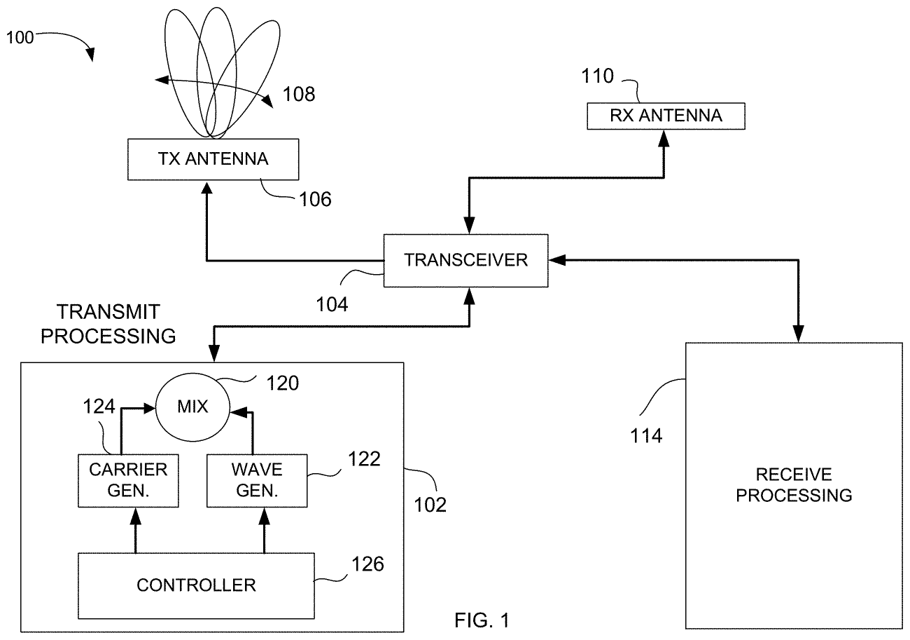

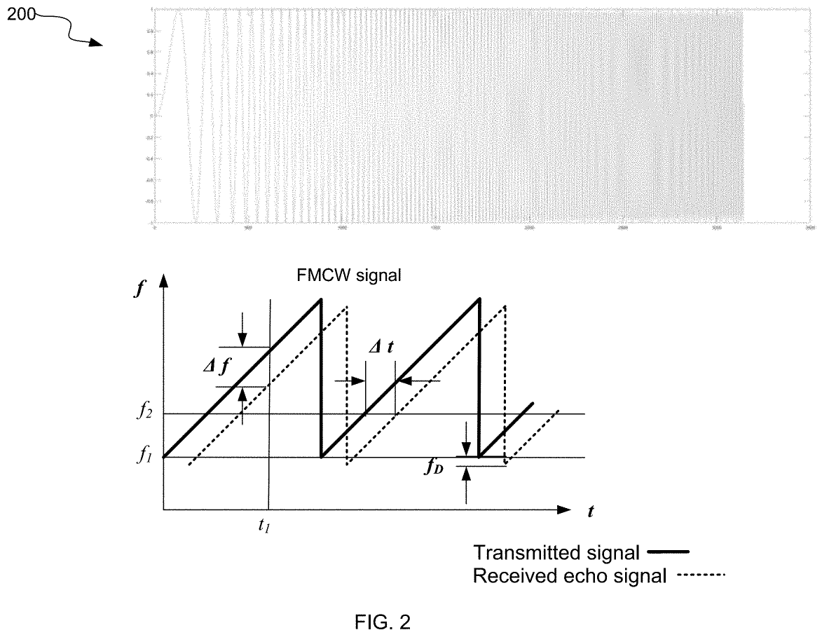

FIG. 1 illustrates a radar system 100 for a vehicle having both transmit and receive processing. A transmit processing unit 102 is coupled to a transceiver 104 and includes a controller 126 to supervise operation of a carrier generator 124 and a wave generator 122, wherein outputs are coupled to a multiplexer 120. Signal information is provided to transceiver 104 coupled to a transmit antenna 106 which steers a beam 108 to cover a Field of View (FoV). The beam radiates through the FoV and returns when it encounters an object or target. Return beams are received at a receive antenna 110 and processed through transceiver 104 and a receive processing 114. The radar system 100 uses an FMCW signal, such as illustrated in FIG. 2, where the frequency changes periodically over time as shown in graph 200 of FIG. 2.

As illustrated at time t₁, the difference in frequency between the transmitted signal and the received echo or return signal is represented as Δf. The Doppler frequency, f_{D} is illustrated at time frequency f₁. The delay, or Δt, is illustrated as the difference in time from transmitted signal to received signal.

In the radar example disclosed herein, the chirp generator provides the chirp signal and waveform which is modulated onto a 77 GHz carrier. Two distinct instances may be used for the transmitter and receiver such that different parameters may be selected. A controller supervises the processing to define sequences of different chirps and chirp configurations. The chirp generation process is done on the transmit and receive paths. Some of the parameters are processed independently for transmit (TX) and receive (RX), including the number of samples per frame, increment per sample for RX, increment per sample for TX, delay between chirps, delayed TX start and delayed RX start. As the signal is digitally generated, there are discrete samples, which may be time units. The increment is the frequency increment per unit time, in contrast to a continuous analog signal. Signal processing provides these and other parameters to the controller. Once one chirp is generated, the control state machine programs the next chirp and starts again. The controller implements a loop so that a set number of different consecutive chirp signals may be generated. In some embodiments, some other independent chirp generators for RX and TX may be implemented, supporting different profiles for RX and TX. The generated waveforms are illustrated in the graph 200 of FIG. 2.

The chirp generator settings may be calculated in software or designated hardware. The parameters may be set directly like velocity, distance and so forth. The number of samples need to be selected such that the desired distance and resolution is captured. The traveling time of the signal translates into a specific frequency, or offset, incurred by delay on demodulation of the received signal. Since the chirp is limited in length, the distance to be covered is also limited. For example, a 300 m distance corresponds to a 1 μs delay; to cover such distance, the chirp signal window is designed for this distance and to have sufficient SNR after demodulation.

The following formulas may be used to implement a chirp signal:

s_{chirp}(t)=A_{chirp}·e^{j·2·π·(f}^{_{lchirp}}^{30 f}^{_{dchirp}}^{·t)·t}

In this way, the frequency is increased based on the delta-frequency f_{dchirp} continuously over time. Each implementation has an upper limit and inputs including a lower frequency, an upper frequency, and a delta-frequency per sample.

In some embodiments, the upper frequency may be replaced by the number of samples to generate. Other waveforms may be used for radar, such as triangular wave. The disclosure described herein are applicable to a variety of waveforms or any other input which allows to derive the desired information. The chirp signal definition includes a lower frequency and an upper frequency as well as the time or period. Some embodiments set a starting frequency, the increment of the frequency per time unit, and the number of steps to complete a chirp. The upper frequency and the total number of samples may be interchangeable used by calculating the following:

f_{uchirp}=f_{lchirp}+f_{dchirp}·N

Alternate embodiments may specify a chirp by other parameters or combination of information.

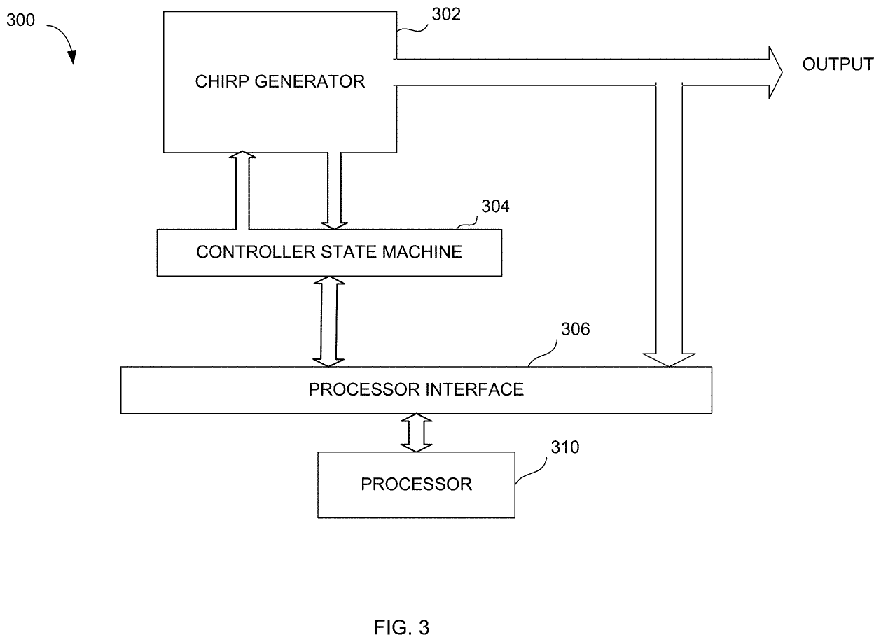

In the example embodiment, a state machine is used to control a chirp generation process. FIG. 3 illustrates a chirp generator module 300 including a chirp generator 302 coupled to a controller state machine (“controller”) 304, a processor interface 306, and an input multiplexer (processor) 310. The chirp generator is an essential portion of both the TX and the RX processing. This document does not provide further details on the TX and RX processing chain itself and solely concentrates on the chirp generator.

The TX processing performs the signal generation steps to generate an appropriate radar signal. Mainly this includes a waveform generator, carrier frequency generator, multiplexer, and controller as in FIG. 1. The chip generator 302 of FIG. 3 illustrates connections and interactions with other components. The controller state machine 304 sets parameters for different scenarios and use cases.

The processor interface 306 controls the state machine 304 and the chirp generator 302, wherein such modules are coupled to other hardware modules (not shown), such as for synchronization purposes and other operational means. For example, the control state machine 304 is coupled through a digital-to-analog (D/A) converter to carrier generator and wave generator which are combined for generation of transmission signals. The processor interface 306 receives the output of chirp generator 302. The controller state machine 304 is coupled to between chirp generator 302 and processor interface 306

The chirp generator 302 is implemented with a sine and cosine generator for in-phase (I) and quadrature (Q) measures which may be based on, for example, a coordinate rotation digital computer (cordic) to calculate trigonometric and other functions. Such implementation is based on the idea that continuous multiplication with a phase angle leads to the desired sine or cosine wave. As described herein, the example uses a complex notation of a signal rather than individually specifying sine and cosine signals. Once the initial settings are determined, the generator performs sine and cosine signal generation by continuous multiplications. When setting the multiply values correctly, they reduce to shift and add without limiting the accuracy to a cordic implementation only. The following symbol definitions are given in Table 1.

TABLE 1
Chirp Terms

| Term | Definition |
|---|---|
| A_{chirp} | Amplitude of the chirp signal (can be normalized to 1.0) |
| e | Euler Number 2.718281828459 |
| j | \sqrt{−1} |
| f_{lchirp} | Lower Chirp Frequency or starting frequency |
| f_{dchirp} | Frequency Change per time unit (second) i.e. delta frequency |
| t | time in the formulas measured in seconds |
| τ | time per sample |

The time, t, is measured in seconds and a calculation is performed at each sample. Depending on the sample rate, the time per sample, τ, provides the time difference between samples. For the present radar application operating at 77 GHz, the sampling rate is several 100 MHz and τ is in the microsecond range.

The chirp generation terms and calculations are given as:

$${s}_{chirp} ( t ) = {A}_{chirp} \cdot {e}^{j \cdot 2 \cdot \cdot ( {f}_{lchirp} + {f}_{dchirp} \cdot t ) \cdot t} = {A}_{chirp} \cdot {e}^{j \cdot 2 \cdot \cdot {f}_{lchirp} \cdot t} \cdot {e}^{j \cdot 2 \cdot \cdot {f}_{dchirp} \cdot {t}^{2}}$$

$$an \text{d:}$$

$${s}_{chirp} ( t + τ ) = {A}_{chirp} \cdot {e}^{j \cdot 2 \cdot \cdot ( {f}_{lchirp} + {f}_{dchirp} \cdot ( t + τ ) ) \cdot ( t + τ )} = {A}_{chirp} \cdot {e}^{j \cdot 2 \cdot \cdot {f}_{lchirp} \cdot ( t + τ )} \cdot {e}^{j \cdot 2 \cdot \cdot ( {f}_{dchirp} \cdot ( t + τ ) ) \cdot ( t + τ )} = {A}_{chirp} \cdot {e}^{j \cdot 2 \cdot \cdot {f}_{lchirp} \cdot t} \cdot {e}^{j \cdot 2 \cdot \cdot {f}_{lchirp} \cdot τ} \cdot {e}^{j \cdot 2 \cdot \cdot {f}_{dchirp} \cdot ( {t}^{2} + 2 \cdot t \cdot τ + {τ}^{2} )} = {A}_{chirp} \cdot {e}^{j \cdot 2 \cdot \cdot {f}_{lchirp} \cdot t} \cdot {e}^{j \cdot 2 \cdot \cdot {f}_{lchirp} \cdot τ} \cdot {e}^{j \cdot 2 \cdot \cdot {f}_{dchirp} \cdot {t}^{2}} \cdot {e}^{j \cdot 2 \cdot \cdot {f}_{dchirp} \cdot 2 \cdot τ \cdot t} \cdot {e}^{j \cdot 2 \cdot \cdot {f}_{dchirp} \cdot {τ}^{2}} .$$

Processing recursively generates e^{j·2·π·f}^{_{dchirp}}^{·2·τ·t} term (in black) and other terms:

sₕₑₗₚ(t)=e^{j·4·π·f}^{_{dchirp}}^{·τ·t}

sₕₑₗₚ(t+τ)=e^{j·4·π·f}^{_{dchirp}}^{·τ·(t+τ)}=e^{j·4·π·f}^{_{dchirp}}^{·τ·t}·e^{j·r·π·f}^{_{dchirp}}^{·τ}^{²}

s_{chirp}(t+τ)=s_{chirp}(t)·sₕₑₗₚ(t)·e^{j·2·π·f}^{_{lchirp}}^{·τ}·e^{j·2·π·f}^{_{dchirp}}^{·τ}^{²}

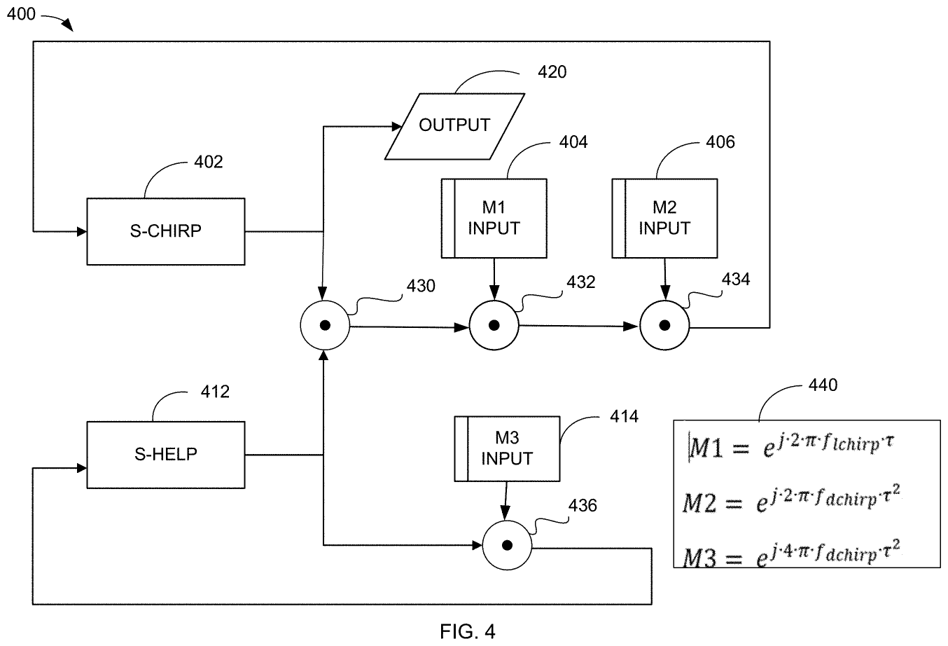

sₕₑₗₚ(t+τ)=sₕₑₗₚ(t)·e^{j·4·π·f}^{_{dchirp}}^{·τ}^{²}

Where the following expressions in the equations above represent the constant values which are multiplied with the existing value and are given as:
e^{j·2·π·f}^{_{lchirp}}^{·τ}
e^{j·2·π·f}^{_{dchirp}}^{·τ}^{²}
e^{j·4·π·f}^{_{dchirp}}^{·τ}^{²}.
   In a hardware solutions and implementations described herein, the initial value is set to 1 (i.e., t=0), as illustrated in FIG. 4, where a circuit or chip generator 400 includes inputs from multiple operands, specifically M1 and M2. The circuit performs complex multiplications and additions, wherein M1, M2 and M3 are operands for the multiplications, as follows:
M1=e^{j·2·π·f}^{_{lchirp}}^{·τ}
M2=e^{j·2·π·f}^{_{dchirp}}^{·τ}^{²}
M3=e^{j·4·π·f}^{_{dchirp}}^{·τ}^{²}.

The chirp generator 400 is a circuit similar to chirp generator 302, the operation of which is determined by the controller state machine 304 and which outputs chirp signals to multiplexer 310. The chirp generator 400 is configured to generate S-CHIRP, the chirp signal, and S-HELP, a temporary intermediate value, by iterative processing through operators 430, 432, 434, and 436. In the present disclosure, operators employ multiplications but may use alternate operations. An S-CHIRP unit 402, which is a memory storage device, is part of the iterative circuit and coupled to an output unit 420. The above operands M1 and M2 are inputs to operators 432 and 434, respectively.

Iterative processing couples S-CHIRP 402 and S-HELP 412 into a loop coupled to operator 430, and S-HELP 412 is also coupled to operator 436. The output of operator 430 and the M1 operator 404 are coupled to operator 432. Generation processing sets the appropriate multipliers, 404, 406, 414, and operators, 432, 434, 436 for chirp generation enabling the chirps to have different starting values and different increments. As values are complex, the generated output is defined by I and Q components. In software embodiments, the process may combine the multiplication of M1 404 and M2406 prior to chirp generation. The hardware components then reduce to three complex multipliers as follows:

M0=M1·M2=e^{j·2·π·f}^{_{lchirp}}^{·τ}·e^{j·2·π·f}^{_{dchirp}}^{·τ}^{²}

The presented method is straightforward, reliable and provides operational flexibility. The sampling rate is a multiple of the highest frequency. Such a fast circuit implementation may incorporate a general-purpose digital signal processing (DSP) for many applications, including radar system applications.

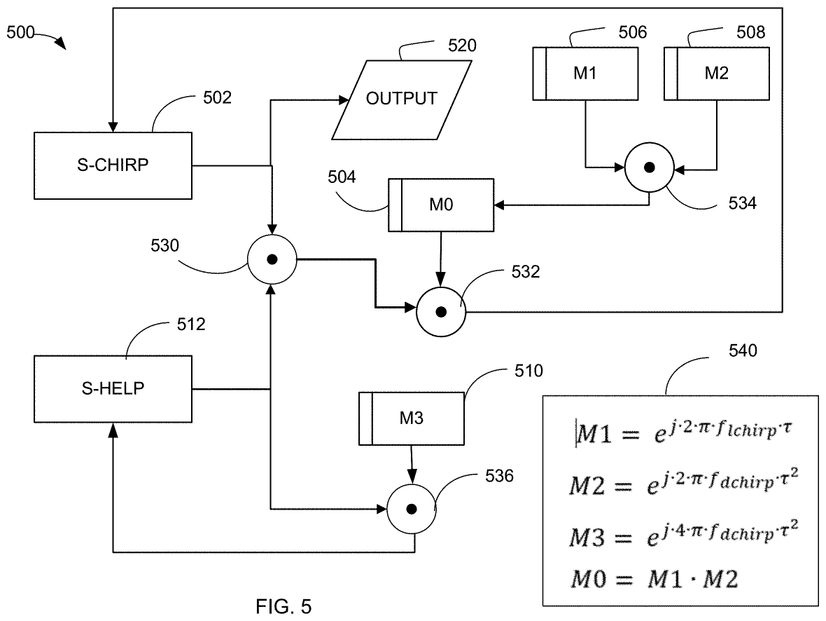

FIG. 5 illustrates a chirp generator circuit 500 having operators 530, 532, 534, and 536. The operands are provided in memory devices or as inputs from another circuit for calculating same. The operands include M1 506, M2 508, and M3 510. The operand M0 504 is the output of operator 534 and is provided as input to operator 532. The mapping module 504 is an interface for the operands.

The controller for chirp generator circuit 500 has several operational modes, including a constant setting for all chirps or N different settings of R×N chirps wherein each chirp is sent R times. A memory mapped parameter matrix is provided as programming interface 540 to set the operands, or parameters. Each chirp is defined by the number of samples and other parameters, including the operands M0 and M3. The parameter M0 may be precalculated in software, as shown above. The chirp generation set up determines the chirp parameters, the value of a gap between each of multiple chirps, the number of repetitions per each chirp, and the corresponding triggering event for each chirp. Since TX and RX chirp events are synchronized, a triggering event may be defined by a master event. If the system is repetitive, the system runs in a loop without any external trigger.

The methods and apparatuses of the present disclosure provide streamlined, dependable, flexible chirp generators without the complexity of other methods. The specifics of the chirp, or parameters defining the chirp, may be programmed during operation and may take on a range of scenarios. The sapling rate is a multiple of the highest frequency. In some examples the number resolutions of 24-32 bit no difference can be found compared to a pure floating point implementation. The present disclosure may be used with an DSP module for many applications.

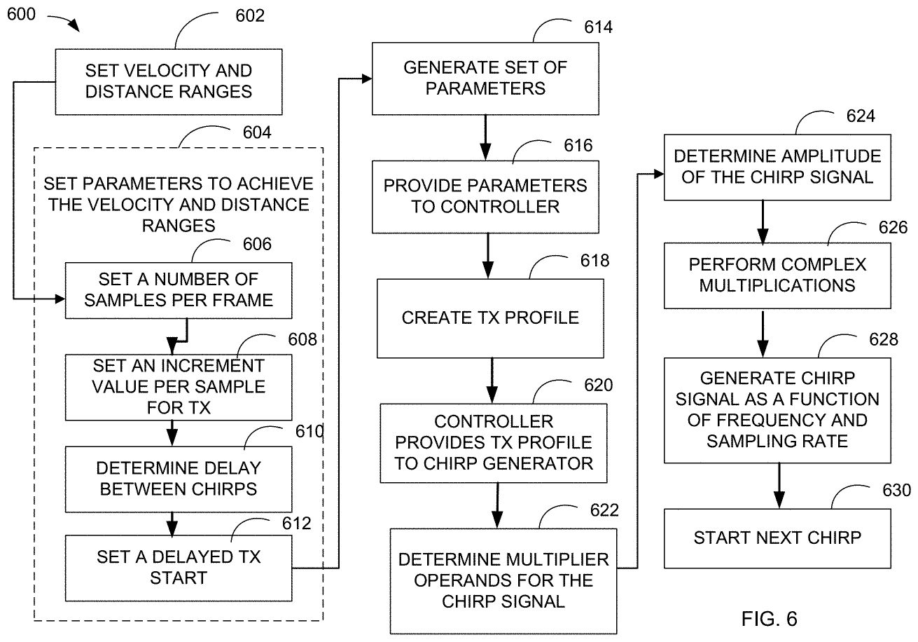

FIG. 6 illustrates a process 600 for the chirp events with triggering function and code for same, in accordance with various embodiments of the subject technology. The process 600 determines a set of velocity and distance ranges, at 602, and sets parameters to achieve the set velocity and distance ranges, at 604. The process 600 sets a number of samples per frame, at 606, sets an increment value per sample for transmit, at 608, determines delay between chirps, at 610, and sets a delayed transmit start, at 612. The process 600 then generates the set of parameters at 614 and provides the set of parameters to a controller at 616. This creates a transmit profile at 618, wherein a controller provides the transmit profile to the chirp generator at 620. The process 600 then determines the multiplier operands, e.g., parameters, for the chirp signal, at 622. The process 600 determines an amplitude of the chirp signal, at 624 and starts the process. The iterative calculations perform complex multiplications, at 626 to generate chirp signals at 628, wherein the chirp signal is a function of frequency and sampling rate, at 628. The process 600 is then prepared to start a next chirp, at 630.

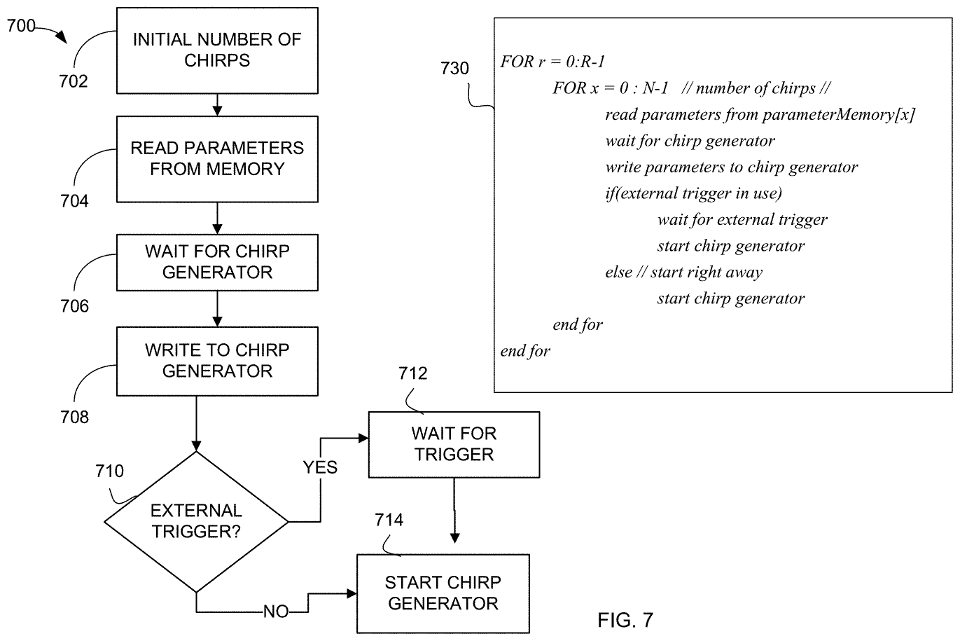

FIG. 7 illustrates a radar process 700, in accordance with various embodiments of the subject technology. The process 700 determines an initial number of chirps, at 702, and reads parameters from memory, at 704. The process 700 waits for chirp generation, at 706 and writes to chirp generator, at 708. If there is an external trigger, at 710, the process 700 waits for the trigger at 712 to start chirp generation, at 714. If there is no external trigger, then the process 700 starts chip generator, at 714 without waiting for the trigger. Pseudo code for the process 700 is illustrated as code 730 as shown in FIG. 7.

The controller may impose a minimum time gap between chirps. Above the minimum, these gaps are programmable as desired. In some embodiments, the chirp generator, such as generator 400 or 500, has an implementable wait time as a parameter for each chirp; this wait time may be combined within a parameter set. The chirp generator is implemented as a recursive formula using only multiplications. This generation method avoids the use of a lookup table as well as sine and cosine calculations, simplifying the recursive process through the use of multiplications.

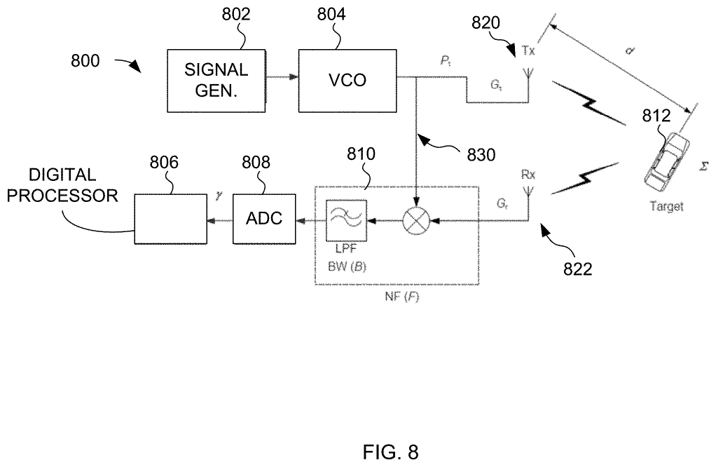

FIG. 8 illustrates a radar system 800 in a vehicle environment and proximate a vehicle target 812, in accordance with various embodiments of the subject technology. A transmit antenna 820 transmits an FMCW signal to a vehicle 812 that is a distanced. A receive antenna 822 receives echoes from vehicle 812 as indicated. The FMCW signals for transmit and receive are synchronized for measurement and comparison purposes. The FMCW signal is generated by a signal generator 802, including a chirp generator, and sent through a voltage-controlled oscillator (VCO) 804 to a transmit antenna 820 and to a receiver 810, which is coupled to receive antenna 822. The received signal is processed in receiver 810 and transmitted to an analog to digital converter (digital processor) 806 for processing in digital processor 806. A coupling 830 enables synchronization of the transmit and receive signals to measure time delays, frequency changes and so forth, as illustrated in FIG. 8.

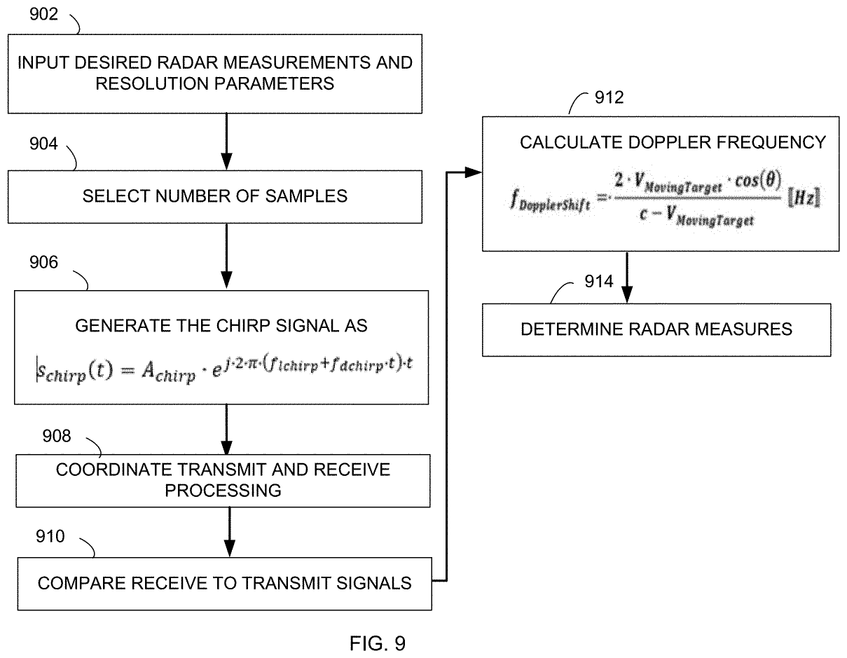

FIG. 9 illustrates a process for incorporating chirp generation according to the present disclosure in a radar system as in FIG. 8. Desired radar measurements and resolution parameters, at 902, and the number of samples, at 904, are used to generate the chirp signal as in equation S-CHIRP hereinabove, at 906. The chirp provides the FMCW signal to transmit antenna and coordinates the transmit and receive processing at 908. At receive, the process compares the received signal to the transmit signal, at 910 and calculates the Doppler frequency, at 912, as illustrated in FIG. 9. The process then determines the desired radar measurements, at 914.

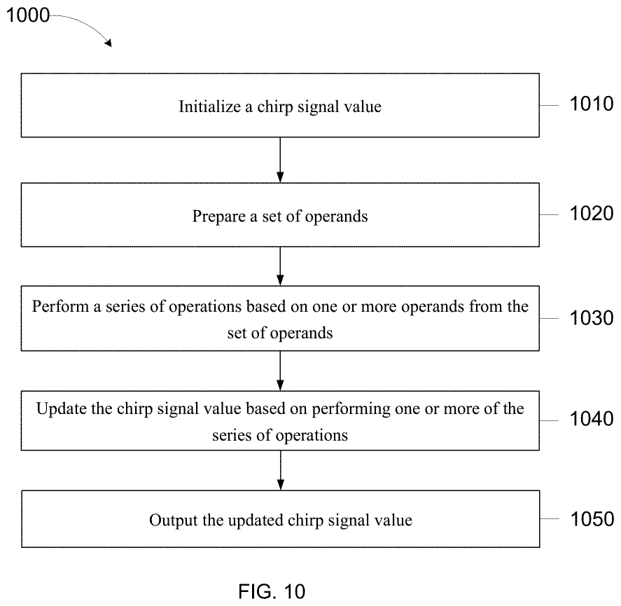

FIG. 10 illustrates a flowchart for a method 1000 of generating a radar signal, in accordance with one or more implementations of the subject technology. The method 1000 for generating a radar signal includes initializing a chirp signal value at 1010; preparing a set of operands at 1020; performing a series of operations based on one or more operands of the set of operands at 1030; updating the chirp signal value based on performing one or more operations from the series of operations at 1040; and outputting the updated chirp signal value at 1050. In accordance with various embodiments of the method 1000, the performing a series of operations based on one or more of the set of operands occurs recursively. In accordance with various embodiments of the method 1000, the updating the chirp signal value by one or more of the series of operations occurs recursively. In accordance with various embodiments, the steps of the method 1000 are iterative and occur recursively.

In various embodiments, the radar signal is a frequency modulated continuous wave (FMCW) signal and the chirp signal value is a portion of the FMCW signal. In various embodiments of the method 1000, the series of operations are complex multiplications and the set of operands further include as follows:
M1=e^{j·2·π·f}^{_{lchirp}}^{·τ}
M2=e^{j·2·π·f}^{_{dchirp}}^{·τ}^{²}
M3=e^{j·4·π·f}^{_{dchirp}}^{·τ}^{²}.

In various implementations, the method 1000 can optionally include multiplying the chirp signal value by a first operand, M1, thereby generating a first product; multiplying the first product by a second operand, M2, thereby generating a second product; and storing the second product as an updated chirp signal value. In various embodiments, the method 1000 can optionally include storing a temporary value; multiplying the temporary value by a third operand, M3, thereby generating a third product; and updating the temporary value with the third product.

In various embodiments, multiplying the chirp signal value by the first operand comprises multiplying a temporary value with the chirp signal value thereby generating a temporary product; and multiplying the temporary product by the first operand, M1, thereby generating the first product.

In various embodiments, the method 1000 can optionally include multiplying the chirp signal value by a first operand, M1; multiplying the first operand and a second operand, M2, thereby generating a first product; and updating the first operand with the first product. In various embodiments, multiplying the chirp signal value by the first operand comprises: storing a temporary value; multiplying the chirp signal value by the temporary value to form a temporary product; and multiplying the temporary product by the first operand to form a second product.

The present disclosure includes modules that generate chirps by reducing a sample multiplied with a phase shift, similar to the CORDIC algorithm, which is used to generate sine and cosine waves by consistently multiplying with a phase shift. The present disclosure applies a simple technique to an FMCW wave that consistently increases the frequency by a defined rate. These methods may be implemented with three complex multiplications, avoiding the use of complex hardware. In some embodiments, the present disclosure may be switched instantaneously to change frequency range with the three parameters described. The embodiments described in the present disclosure are implemented without a lookup table (LUT) and therefore without table value recalculation or upload and update of such tables for different chirp setups. Other solutions require complex phase locked loop (PLL) solutions that incur ripple effects. In contrast to the present disclosure, prior solutions implement filters to remove harmonics and other undesirable effects. The present disclosure does not require complex interpolation circuitry.

The present disclosure avoids storage tables and the recalculation and uploading of these tables for various scenarios. The present disclosure avoids the use of PLL and its related filters to remove harmonics. The present disclosure avoids complex interpolation circuitry.

In accordance with various embodiments and implementations disclosed herein, a method for generating a radar signal is provided. The disclosed method includes initializing a chirp signal value, preparing a set of operands, performing a series of operations based on one or more operands provided in the set, updating the chirp signal value based on performing one or more operations provided in the series of operations, and outputting the updated chirp signal value. In various embodiments, any one of the method steps can be performed iteratively or recursively. In various embodiments, the radar signal being generated is a frequency modulated continuous wave (FMCW) signal and the chirp signal value is a portion of the FMCW signal.

In various embodiments, the series of operations are complex multiplications and the set of operands further include M1=e^{j·2·π·f}^{_{lchirp}}^{·τ, M}2=e^{j·2·π·f}^{_{dchirp}}^{·τ}^{²}, M3=e^{j·4·π·f}^{_{dchirp}}^{·τ}^{²}.

In various implementations, wherein the performing includes multiplying the chirp signal value by a first operand, M1, thereby generating a first product. The method can also include multiplying the first product by a second operand, M2, thereby generating a second product. The method further includes storing the second product as the updated chirp signal value. In various embodiments, the method further includes storing a temporary value, multiplying the temporary value by a third operand, M3, thereby generating a third product, and updating the temporary value with the third product.

In various embodiments, the method further includes multiplying a temporary value with the chirp signal value thereby generating a temporary product, and multiplying the temporary product by the first operand, M1, thereby generating the first product.

In various embodiments, the method further includes multiplying the chirp signal value by a first operand, M1. The method can also include multiplying the first operand and a second operand, M2, thereby generating a first product; and updating the first operand with the first product. In various embodiments, multiplying the chirp signal value by the first operand comprises storing a temporary value and multiplying the chirp signal value by the temporary value to form a temporary product. The method can also include multiplying the temporary product by the first operand to form a second product.

In accordance with various embodiments and implementations disclosed herein, a signal generation system is provided. The signal being generated by the signal generation system includes a frequency modulated continuous wave (FMCW) signal. The signal generation system includes a controller configured to set parameters for signal generation and a chirp generator coupled to the controller.

In various embodiments, the chirp generator includes a plurality of multiplication modules, a plurality of operand units, and an output storage unit. In various embodiments, each operand unit can store an operand and each operand unit can be coupled to a multiplication module of the plurality of multiplication modules. In the disclosed signal generation system, the system includes a parameter interface module coupled to the controller and configured to set an operand value for each of the plurality of operand units.

In various embodiments, the signal generation system further includes a multiplexer coupled to the output storage unit. In various embodiments, the signal generation system further includes a carrier signal generator coupled to the multiplexer. In various embodiments of the signal generation system, the controller is adapted to calculate a set of operands, wherein the set of parameters includes one or more FMCW chirp parameters. In various embodiments, the signal generation system is part of a radar system.

In accordance with various embodiments and implementations disclosed herein, a chirp generator for a frequency modulated continuous wave (FMCW) signal unit is provided. The chirp generator includes a unit configured to control recursive calculation of a chirp signal, a plurality of operational units coupled in series, and a plurality of operand storage units coupled to the plurality of operational units, wherein operation of the plurality of operational units generates the chirp signal.

In various embodiments, the chirp generator further includes a chirp generator storage unit and a temporary storage unit coupled to the plurality of operational units. In various embodiments, the chirp generator further includes an output storage unit coupled to the chirp generator storage unit and a multiplexer coupled to the output storage unit.

In various embodiments of the chirp generator, the unit to control recursive calculation of the chirp signal is adapted to calculate a plurality of operands as M1=e^{j·2·π·f}^{_{lchrip}}^{·τ}, M2=e^{j·2·π·f}^{_{dchirp}}^{·τ}^{²}, M3=e^{j·4·π·f}^{_{dchirp}}^{·τ}^{²}. In various embodiments, the plurality of operands can also include M0, which is equal to MI multiplied by M2. In various embodiments, the chirp generator is part of a radar system.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A method for generating a radar signal, comprising:
initializing a chirp signal value;
preparing a set of operands;
performing a series of operations based on one or more operands from the set of operands;
updating the chirp signal value based on performing one or more operations from the series of operations; and
outputting the updated chirp signal value.

2. The method as in claim 1, wherein the series of operations are complex multiplications and the set of operands further comprises:
M1=e^{j·2·π·f}^{_{lchirp}}^{·τ}
M2=e^{j·2·π·f}^{_{dchirp}}^{·τ}^{²}
M3=e^{j·4·π·f}^{_{dchirp}}^{·τ}^{²}.

3. The method as in claim 2, wherein the performing comprises:
multiplying the chirp signal value by a first operand, M1, thereby generating a first product; and
multiplying the first product by a second operand, M2, thereby generating a second product; and
wherein the method further comprises storing the second product as the updated chirp signal value.

4. The method as in claim 3, further comprising:
storing a temporary value;
multiplying the temporary value by a third operand, M3, thereby generating a third product; and
updating the temporary value with the third product.

5. The method as in claim 3, wherein multiplying the chirp signal value by the first operand comprises:
multiplying a temporary value with the chirp signal value thereby generating a temporary product; and
multiplying the temporary product by the first operand, M1, thereby generating the first product.

6. The method as in claim 2, further comprising:
multiplying the chirp signal value by a first operand, M1;
multiplying the first operand and a second operand, M2, thereby generating a first product; and
updating the first operand with the first product.

7. The method as in claim 6, wherein multiplying the chirp signal value by the first operand comprises:
storing a temporary value;
multiplying the chirp signal value by the temporary value to form a temporary product; and
multiplying the temporary product by the first operand to form a second product.

8. The method as in claim 1, wherein the radar signal is a frequency modulated continuous wave (FMCW) signal and the chirp signal value is a portion of the FMCW signal.

9. A signal generation system, comprising:
a controller configured to set parameters for signal generation;
a chirp generator coupled to the controller, comprising:
a plurality of multiplication modules,
a plurality of operand units, each operand unit storing an operand, each operand unit coupled to a multiplication module of the plurality of multiplication modules, and
an output storage unit; and
a parameter interface module coupled to the controller and configured to set an operand value for each of the plurality of operand units.

10. The signal generation system as in claim 9, further comprising:
a multiplexer coupled to the output storage unit.

11. The signal generation system as in claim 9, wherein the signal being generated is a frequency modulated continuous wave (FMCW) signal.

12. The signal generation system as in claim 10, further comprising:
a carrier signal generator coupled to the multiplexer.

13. The signal generation system as in claim 9, wherein the controller is adapted to calculate a set of operands, and wherein the set of parameters comprises one or more FMCW chirp parameters.

14. The signal generation system as in claim 13, wherein the signal generation system is part of a radar system.

15. A chirp generator for a frequency modulated continuous wave (FMCW) signal unit, comprising:
a unit configured to control recursive calculation of a chirp signal;
a plurality of operational units coupled in series; and
a plurality of operand storage units coupled to the plurality of operational units, wherein operation of the plurality of operational units generates the chirp signal.

16. The chirp generator as in claim 15, further comprising:
a chirp generator storage unit; and
a temporary storage unit coupled to the plurality of operational units.

17. The chirp generator as in claim 16, further comprising:
an output storage unit coupled to the chirp generator storage unit; and
a multiplexer coupled to the output storage unit.

18. The chirp generator as in claim 15, wherein the unit to control recursive calculation of the chirp signal is adapted to calculate a plurality of operands as:
M1=e^{j·2·π·f}^{_{lchirp}}^{·τ}
M2=e^{j·2·π·f}^{_{dchirp}}^{·τ}^{²}
M3=e^{j·4·π·f}^{_{dchirp}}^{·τ}^{²}.

19. The chirp generator as in claim 18, wherein the plurality of operands further comprises M0, which is equal to M1 multiplied by M2.

20. The chirp generator as in claim 15, wherein the chirp generator is part of a radar system.
